(19) United States
(12) Patent Application Publication
(10) Pub. No.: US 2024/0302815 A1
(43) Pub. Date: Sep. 12, 2024

(54) ENHANCED APPROACH FOR INDUSTRIAL PLANT EQUIPMENT IDENTIFICATION AND MEASUREMENT READING

(71) Applicant: Yokogawa Electric Corporation, Tokyo (JP)

(72) Inventor: Jinsong QIAN, Bedok (SG)

(21) Appl. No.: 18/119,707

(22) Filed: Mar. 9, 2023

(51) Int. Cl. G05B 19/406

(52) U.S. Cl. CPC G05B 19/406; G05B 2219/31396

(57) ABSTRACT

Identifying a particular industrial asset at an industrial site can be a daunting task. A particular industrial asset may be one of many, and misidentification may lead to performing an unnecessary or harmful operation on a different industrial asset or omitting a needed operation on the intended industrial asset. By utilizing image information along with location information and any secondary information (e.g., sound, alarms, etc.), an industrial asset may be correctly identified and managed. Management may enable the performance of an operation and/or the recordation of a value of the industrial asset.

### FIELD OF THE DISCLOSURE

The invention relates generally to systems and methods for machine-based identification of industrial assets and operations therewith.

### BACKGROUND

An industrial site, such as a factory, power plant, processing plant, etc., may comprise hundreds or thousands of pieces of equipment to be monitored. An operator performing field operations and patrolling the site may be required to perform routine observations (e.g., record the value of a reading displayed on a piece of industrial equipment), check for alarms, look for maintenance issues, or otherwise ensure the industrial equipment is operating as expected.

In the prior art, an operator accesses their operations management application on a mobile device and selects the target equipment. In many modern industrial sites, this can be a daunting task. The operator may be exposed to adverse weather conditions, have difficulty seeing the screen due to glare or sunlight, or have difficulty operating the mobile device due to wearing gloves or other protective equipment. Selecting the correct piece of equipment is made more challenging by the limited size of the screen provided by mobile devices.

After the equipment has been identified, hopefully accurately, the operator may be presented with a task to perform on the equipment, such as to record a reading, report a state of the equipment, or perform an operation on the equipment. While such operations have been performed routinely, the opportunity to misidentify the particular piece of equipment is an ongoing risk. If an operation is performed on the misidentified piece of equipment, or the operation is omitted from the intended piece of equipment, the result may lead to inefficiencies or failures that may cascade to other pieces of equipment.

### SUMMARY

These and other needs are addressed by the various embodiments and configurations of the present invention. The present invention can provide a number of advantages depending on the particular configuration. These and other advantages will be apparent from the disclosure of the invention(s) contained herein.

In one embodiment, equipment installed at a location, such as industrial assets at an industrial site, are identified via machine vision supplemented with secondary data from a sensor other than a camera utilized to capture the equipment's image. The secondary data is variously embodied and may include location data, such as global positioning system (GPS), equipment description (e.g., type, size, orientation, connected or attached components, etc.), alarm data (e.g. alarm types, alarm attributes/properties, etc.). In response to identifying the equipment, an operation may be presented on a mobile device. The operation to be performed includes, but is not limited to, obtaining a reading from a non-networked output device (e.g., gage, sight glass, etc.), obtaining a state (e.g., vibration, leaks, damage, etc.), and/or performing an operation on the equipment (e.g., changing a setting, replacing a component, maintenance, clearing an alarm, updating software, disabling, enabling, etc.).

In another embodiment, image data is fused with secondary data graphically, such as to produce a digital image of the equipment that also provides indicia (text and/or graphical) of the sensor data (e.g., gauge values, states, etc.).

In another embodiment, image data is fused with secondary data in a data structure or record.

In another embodiment, a disagreement/mismatch between the image data and the sensor data automatically triggers a response. A data structure may exist for the equipment comprising image and secondary data. If a mismatch occurs between an image taken in the field and the image or secondary data, a mismatch resolution is energized. For example, an operator may capture an image of a piece of equipment at a particular location, however, a record may show that the particular piece of equipment is at a different location and/or the equipment imaged is different from the equipment image expected. The mismatch resolution may comprise an alert, a prompt to re-baseline the equipment at the particular location, disabling operations that may be performed (until the mismatch is resolved), and/or another operation.

In another embodiment, an artificial intelligent agent, such as a neural network, is trained with images and provided with an equipment image to identify the piece of equipment and identify key features (e.g., gauge, meter, lever position, etc.). GPS, or other location information, is fused with images in a first fusion data. Identified key features may be automatically added to a record (see “third fusion” below). As a benefit, speed and accuracy is improved in correctly identifying the equipment and recording an observation in a record associated with the correctly identified equipment.

In another embodiment, additional data is retrieved and combined with the first fusion data to create a second fusion data. The additional data may include equipment description, alarm data, process data (real time/live), or process data (historical). The first and second fusion data may be fused graphically (e.g., in a digital image). Accordingly, textual or other data not originating in graphical form is converted to pixels and overlayed onto the equipment image to create a single digital image of the equipment/industrial asset and any or all other data. A third fusion may then be performed wherein the image comprises graphical representations of current readings (e.g., gauge values, settings, alarms, etc.). A feedback loop may include any one or more of the first, second, or third fusions to aid in subsequent identifications and operations of equipment.

As one example, a plurality of images are captured of a tank showing a volume indicia (e.g., a level gauge, dial, sight glass, etc.) and provided as training images to a neural network. Based on current or prior training, the neural network identifies key features in the image, such as gauges, positions of levers, etc. Next, location (e.g., GPS) data and other sensor data (e.g., noise) are fused with the images in a first fusion of data. Location data may have varying degrees of precision. For example, GPS readings often have signal noise that provides location data that is accurate to within ten meters. Sensor data, such as noise levels, at various distances and/or direction from the equipment is captured, such as to create GPS configuration space data, describing the environment at the location and proximate to the equipment. The GPS configuration space data is pixelated and added to the image(s) of the equipment.

Continuing the example, an initial list of equipment candidates are identified from the first data fusion (e.g., GPS configuration space data). The candidate list may originate from a master equipment list of all equipment at an industrial site and filter out only those pieces of equipment that are proximate to the location, within a previously determined distance, such as ten meters. Next, master equipment data is retrieved which may a listing of equipment and reference data comprising one or more of alarm data, process data (live), process data (historical), fuse the above data with the images, which is then added in a second fusion. The retrieved master equipment data may be converted to pixel data and added to the image along with other pixelized data (e.g., location data). The location data may be given in coordinates (e.g., latitude and longitude, grid or sector of an industrial site) or other indicator (e.g., distance(s) from reference point(s), direction(s) to reference point(s), etc.).

The live and historical data (e.g., readings of temperature, pressure, alarm data, etc.) are similarly converted to pixels and added to the image(s).

In one embodiment, the mechanism to fuse/insert the location and/or secondary data, and thereby create the processed data, comprises creating an image or array of pixel matrix to represent the location and/or secondary data on the image. This mechanism may include converted data (original image data, alarm data, process data and GPS/location data) into a textual combination of pixels or symbolically encoded, similar to a Quick Response (QR) or other bar code. A neural network may be trained on the images comprising the pixels of the data stored in the images, such as to identify the equipment, identify a state of the equipment, identify the portion of an image comprising a key feature, and preserving the readings obtained from the key feature, such as adding pixel representations thereof to an image of the equipment.

Exemplary aspects are directed to:

A method of identifying tasks associated with an industrial asset, the method comprising: obtaining a plurality of images associated with the industrial asset; creating a first set of images, wherein the first set of images comprises location data associated with the plurality of images; determining a plurality of target industrial assets based on the first set of images; retrieving process data associated with the plurality of target industrial assets; creating a second set of images, wherein the second set of images comprises the process data and the first set of images; identifying a target industrial asset within the plurality of target industrial assets based on the second set of images, wherein the target industrial asset is identified by determining that a degree of match between an image of the target industrial asset and at least one image from the plurality of images satisfies a predetermined threshold; and based on identifying the target industrial asset, automatically retrieving a task associated with the target industrial asset.

A method, comprising: capturing a captured image of a candidate industrial asset on a portable device; in response to capturing the captured image, accessing a captured environmental input related to the candidate industrial asset; accessing a data record comprising indicia of the candidate industrial asset and at least one reference image of the candidate industrial asset accompanied by a reference environmental input; and determining that a degree of match between the captured image and the reference image and between the captured environmental input and the reference environmental input is above a predetermined threshold; and in response to determining that the degree of match is above the predetermined threshold, enabling at least one management feature of the candidate industrial asset.

A portable device for managing an industrial asset, comprising: a processor coupled to computer memory comprising computer-executable instructions; a data storage; a camera operable to capture an image of an already-captured image and provide the image of the already-captured image to the processor thereby enabling the processor to; determines an captured environmental input related to an industrial asset in the image of the already-captured image; obtain a reference image of the industrial asset; obtain a reference environmental input of the industrial asset; determine that a degree of match between the image of the already-captured image and the reference image and/or between the captured environmental input and the reference environmental input is above a predetermined threshold; and in response to determining that the degree of match is above the predetermined threshold, enable at least one management feature of the industrial asset.

A method of identifying tasks associated with an industrial asset, the method comprising: obtaining a plurality of images associated with the industrial asset; creating a first set of images, wherein the first set of images comprises location data associated with the plurality of images; identifying a plurality of target industrial assets based on the first set of images; retrieving process data associated with the plurality of target industrial assets; creating a second set of images, wherein the second set of images comprises the process data and the first set of images; identifying a target industrial asset within the plurality of target industrial assets based on the second set of images; and automatically retrieving a task associated with the target industrial asset.

A method for managing an industrial asset, comprising: capturing a captured image of a candidate industrial asset on a portable device; in response to capturing the captured image, accessing a captured sensor value from a sensor of the portable device; accessing a data record comprising indicia of the industrial asset and at least one reference image of the industrial asset and a reference sensor value; and determining that a degree of match between the captured image and the reference image and between the captured sensor value and the reference sensor value is above a threshold, enabling at least one management feature of the industrial asset.

A portable device for managing an industrial asset, comprising: a processor coupled to computer memory comprising computer-executable instructions; a data storage; a camera operable to capture a captured image and provide the captured image to the processor; a sensor operable to sense a location-specific attribute of the portable device to determine therefrom a captured sensor value and provide the captured sensor value to the processor; and wherein the processor performs: in response receiving the captured image, accessing a captured image from the data storage; accessing, from the data storage, a reference image of the industrial asset and a reference sensor value of the industrial asset; and determining that a degree of match between the captured image and the reference image and between the captured sensor value and the reference sensor value is above a threshold, enabling at least one management feature of the industrial asset.

Any of the above aspects may also include:

Wherein creating the first set of images comprises: converting the location data to a first multi-dimensional dataset.

Wherein creating the second set of images comprises: converting the process data to a second multi-dimensional dataset.

Further comprising creating a third set of images, wherein the third set of images comprises the second set of images and the process data associated with the plurality of target industrial assets.

Further comprising determining one or more measurement readings associated with the target industrial asset based on the third set of images.

Further comprising: determining that either the degree of match between the captured image and the reference image or the degree of match between the captured environmental input and the reference environmental input is not above the predetermined threshold, blocking an operation associated with the at least one management feature of the candidate industrial asset.

Wherein the captured image comprises an artifact unique to a single industrial asset of all industrial assets at an industrial site.

Wherein the captured environmental input comprises one or more acoustic values indicating at least one of volume, frequency, and variation in volume over a provided time unit, or variation in frequency over the provided time unit.

Wherein of the captured environmental input comprises at least one of a global positioning system (GPS) coordinate, a sensor reading, alarm data, equipment master data (usually comprising threshold data associated with measurement), and process data.

Further comprising: retrieving, from a database, one or more historical environmental inputs associated with the candidate industrial asset; validating that the candidate industrial asset corresponds to a targeted industrial asset; in response to validating that the candidate industrial asset corresponds to the targeted industrial asset, retrieving a task associated with the targeted industrial asset; and automatically filling in at least one measurement reading for the task associated with the targeted industrial asset.

Further comprising retrieving historian data comprising historical readings associated with the candidate industrial asset; and merging the historian data with the captured image.

Further comprising predicting a reading for the candidate industrial asset based on the historian data; and verifying the predicted reading for the candidate industrial asset matches an actual reading for the candidate industrial asset.

Wherein determining the degree of match between the captured image and the reference image comprises providing the captured image to a neural network trained to identify industrial assets from images and providing indica of the match therefrom.

Further comprising collecting a set of industrial asset images from a database; applying one or more transformations to each industrial asset image including mirroring, rotating, cropping, magnifying, demagnifying, translating, smoothing, or contrast reduction to create a modified set of digital industrial asset images; creating a first training set comprising the collected set of digital industrial asset images, the modified set of digital industrial asset images, and a set of digital non-industrial asset images; training the neural network in a first stage using the first training set; creating a second training set for a second stage of training comprising the first training set and digital non-industrial asset images that are incorrectly detected as industrial asset images after the first stage of training; and training the neural network in the second stage using the second training set.

Further comprising collecting at least one of process data and alarm data associated with an industrial site; creating a training set based on the collected at least one of process data and alarm data associated with the industrial site; training a neural network using the training set; confirming that the neural network has been sufficiently trained using the training set; and providing the neural network, once sufficiently trained, with the captured environmental input for purposes of identifying the candidate industrial asset.

Further comprising collecting a set of industrial asset sensor values from a database; applying one or more transformations to each industrial asset sensor value in the set of industrial asset sensor values; fusing the captured image with the one or more transformations to each industrial asset sensor value by changing pixel data in the captured image.

Further comprising a display device, wherein the processor is further enabled to: display information describing a task associated with the at least one management feature of the industrial asset.

Wherein the captured environmental input comprises at least one of a global positioning system (GPS) coordinate, a sensor reading, alarm data, equipment master data, and process data.

Wherein creating the first set of images comprises: converting the location data to a first multi-dimensional dataset.

Wherein creating the second set of images comprises: converting the process data to a second multi-dimensional dataset.

Further comprising creating a third set of images, wherein the third set of images comprises the second set of images and the process data associated with the plurality of target industrial assets.

Further comprising identifying one or more measurement readings associated with the target industrial asset based on the third set of images.

Further comprising determining that either the degree of match between the captured image and the reference image or the degree of match between the captured sensor value and the reference sensor value is not above the threshold, omitting blocking operation of the at least one management feature of the industrial asset and energizing a mismatch feature of the portable device.

Wherein the captured image comprises an artifact unique to a single industrial asset of all industrial assets at an industrial site.

Wherein each of the captured sensor value and the reference sensor value are acoustic values further comprising indicia of at least one of volume, frequency, and variation in volume over a provided time unit, or variation in frequency over the provided time unit.

Wherein each of the captured sensor value and the reference sensor value are location signals further comprising indicia of global positioning system (GPS) coordinates.

Wherein each of the captured sensor value and the reference sensor value are location signals further comprising indicia of at least one of strength of an electromagnetic signal, direction to a source of electromagnetic signals, or an identifier of the source of electromagnetic signals encoded in the electromagnetic signal and wherein the source of electromagnetic signals reaches the industrial asset and does not reach at least one other industrial asset at an industrial site.

Wherein each of the captured image and the reference image comprise a thermal image.

Wherein the management feature comprises at least one of capturing a state of the industrial asset or altering an operational parameter of the industrial asset.

Wherein determining the degree of match between the captured image and the reference image comprises providing the captured image to a neural network trained to identify industrial assets from images and providing indica of the match therefrom.

Wherein the neural network is trained, comprising: collecting a set of industrial asset images from a database; applying one or more transformations to each industrial asset image including mirroring, rotating, cropping, magnifying, demagnifying, translating, smoothing, or contrast reduction to create a modified set of digital industrial asset images; creating a first training set comprising the collected set of digital industrial asset images, the modified set of digital industrial asset images, and a set of digital non-industrial asset images; training the neural network in a first stage using the first training set; creating a second training set for a second stage of training comprising the first training set and digital non-industrial asset images that are incorrectly determined as industrial asset images after the first stage of training; and training the neural network in the second stage using the second training set.

Wherein determining the degree of match between the captured sensor value and the reference sensor value comprises providing the captured sensor value to a neural network trained to identify industrial assets from values from sensors and providing indica of the match therefrom.

Wherein the neural network is trained, comprising: collecting a set of industrial asset sensor values from a database; applying one or more transformations to each industrial asset sensor value including altering a volume, altering a frequency, altering the range of variations in volume over a provided time unit, or altering a range of variation in frequency over the provided time unit, altering a strength of an electromagnetic signal, or altering a direction to a source of electromagnetic signals to create a modified set of industrial asset sensor values; creating a first training set comprising the collected set of industrial asset sensor values, the modified set of industrial asset sensor values, and a set of non-industrial asset sensor values; training the neural network in a first stage using the first training set; creating a second training set for a second stage of training comprising the first training set and digital non-industrial sensor values that are incorrectly detected as industrial asset sensor values after the first stage of training; and training the neural network in the second stage using the second training set.

Wherein each of the captured sensor value and the reference sensor value are acoustic values further comprising indicia of at least one of volume, frequency, variations in volume over a provided time unit, or variation in frequency over the provided time unit.

Wherein each of the captured sensor value and the reference sensor value are location signals further comprising indicia of global positioning system (GPS) coordinates.

A system on a chip (SoC) including any one or more of the above aspects of the embodiments described herein.

One or more means for performing any one or more of the above aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a data transformation provided in accordance with embodiments of the present disclosure;

FIG. 3 depicts a process flow in accordance with embodiments of the present disclosure;

FIG. 4 depicts a process in accordance with embodiments of the present disclosure;

FIG. 5 depicts a process in accordance with embodiments of the present disclosure;

FIG. 6 depicts a process in accordance with embodiments of the present disclosure; and

FIG. 7 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

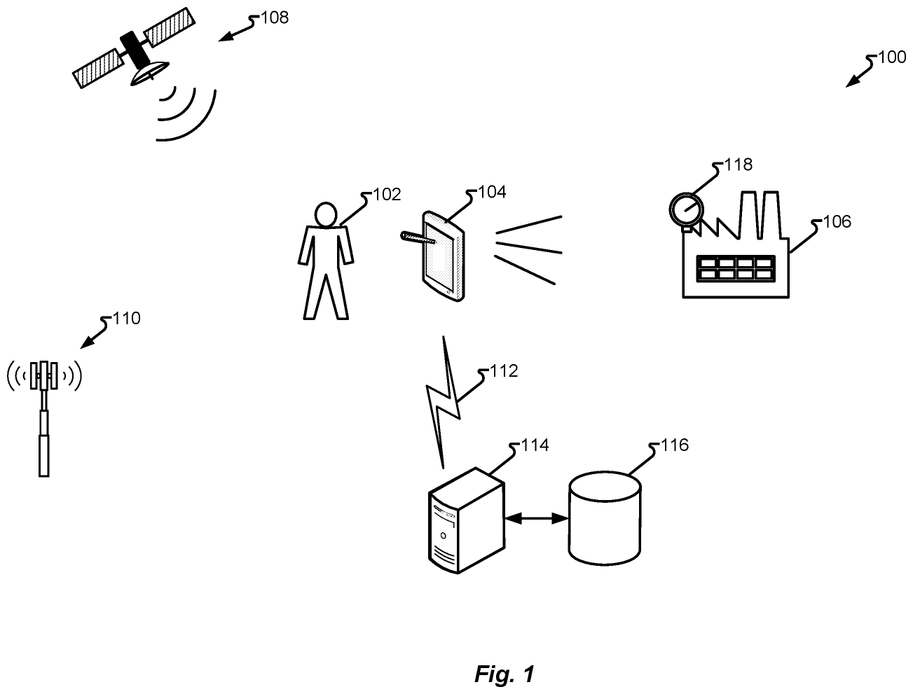

FIG. 1 depicts system 100 in accordance with embodiments of the present disclosure. In one embodiment, operator 102 utilizes mobile device 104 to capture an image of industrial asset 106, such as a piece of equipment utilized in an industrial process, including, but not limited to, pumps, generators, valves, distribution manifolds, forming machines, mixing machines, separating machines, material handling equipment, heaters, coolers, etc.

In many industrial sites, a particular industrial asset 106 may be one of many, even thousands, of similarly looking components of the industrial site. Being able to correctly identify the particular industrial asset 106 ensures that a corresponding record of industrial asset 106 is utilized for the management and operation of industrial asset 106. For example, industrial asset 106 may be one of many similar assets that has triggered an alarm, such as an operation that is falling outside of normal operational parameters. The alarm may not be apparent to operator 102, such as when a related component reports the alarm. For example, industrial asset 106 may be a valve, and a motor operating the valve mechanism is reporting an exceptionally high level of force needed to operate the valve. Visually, the valve appears identical to a number of other valves. However, the particular valve requires maintenance and, if not correctly identified as the industrial asset 106 associated with the alarm, a maintenance task may be incorrectly applied to a different valve. The valve receiving the maintenance may be wasted effort and the valve needing the maintenance may further degrade or fail.

In order to correctly identify industrial asset 106, mobile device 104 comprises a camera. The camera may capture an image of industrial asset 106 in the visible portion of the spectrum or, in other embodiments, invisible (e.g., infrared, ultraviolet, x-ray, etc.). Mobile device 104 may identify industrial asset 106 by the image captured at a known position of mobile device 104. Optionally, the camera may capture other location—or equipment-identifying attributes, that may be indicated optically. For example, one piece of equipment may be well illuminated whereas other similar pieces of equipment are more dimly illuminated. Therefore, an image of a candidate piece of equipment may be determined if the ambient lighting is above a level known to exclude the dimly lit equipment. Similarly, industrial asset 106 may comprise indicia that are unique, or at least unique between all similar assets at an industrial site. The indica may be explicit (e.g., a number on a placard identifying the asset) or implicit (e.g., the only asset next to the stairs, the only asset with a dent, etc.).

Accordingly, mobile device 104 may comprise (or access) other sensing components beyond the camera. For example, a GPS antenna and circuitry may receive signals from positioning satellite 108 and/or positioning antenna 110 (e.g., cellular, Wi-Fi, LORAN, or other location determining signals). It should be appreciated that the use of positioning satellite 108 and/or positioning antenna 110 may comprise a plurality of positioning satellite 108 and/or a plurality of positioning antenna 110. While for unknown or unbounded areas, it is generally necessary to have two sources (e.g., two or more of positioning satellite 108 or positioning antenna 110) in order to perform triangulation, a single source with distance determining functionality may be sufficient in an industrial setting. For example, industrial asset 106 may be one of a number of similar assets, each of which is placed in a row. Positioning antenna 110 may be placed at the end of a row and, therefore, knowing the distance (in any direction) from a single positioning antenna 110 is sufficient to determine the location of mobile device 104 while in the row.

In other embodiments, alone or in conjunction with other sensing components and sensing data, the sensor comprises other sensed data. For example, mobile device 104 may comprise a microphone to capture sounds and/or sound attributes (e.g., amplitude data, frequency data, ranges thereof, etc.). Sensors may include thermometers or thermal imaging components, magnetometers, or a compass (or another direction determining component).

Once correctly identified, an operation on mobile device 104 or another device may be enabled. Such as a feature that enables the gathering/accessing of current industrial asset 106 information, such as the parameter value(s) indicated by gauge 118.

Mobile device 104 may maintain or intermittently establish a communication via networking link 112 to server 114 having one or more microprocessors (processors) and further comprising or accessing data storage 116 for the storage and retrieval of data thereon. Server 114 may provide computational services that may not be possible or practical utilizing mobile device 104 or may require data available on data storage 116 but not available on mobile device 104. Server 114 may be embodied as a single processor, multiple processors, an array, a cloud, fabric, or other processing platform and, in one embodiment, is co-embodied with mobile device 104. Server 114 may perform computationally intensive tasks, such as training and executing one or more neural networks used to identify, manage, and record aspects of industrial asset 106.

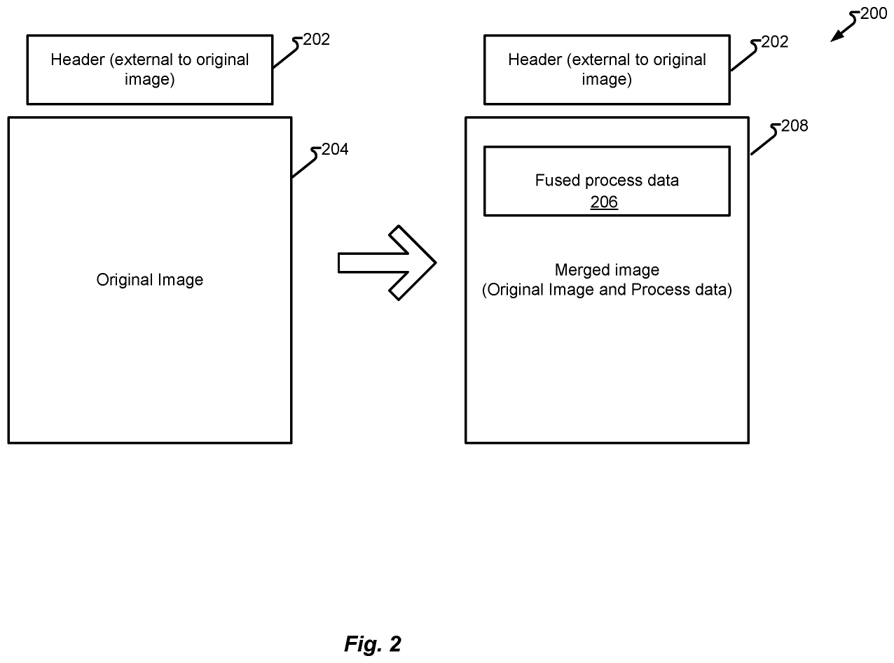

FIG. 2 depicts data transformation 200 provided in accordance with embodiments of the present disclosure. In one embodiment, image 204 is captured by mobile device 104. Image 204 may be associated with, but external to, the image file header 202. Mobile device 104 and/or server 114 receives image 204 and data from one or more external sensors (e.g., GPS locations, noise levels, etc., temperature, pressure) and encodes the data as pixels of image 208 comprising fused processed data 206. Fused process data 206 may be pixels arranged in a human-readable form (e.g., text) or in machine-readable form (e.g., binary or other machine-readable form).

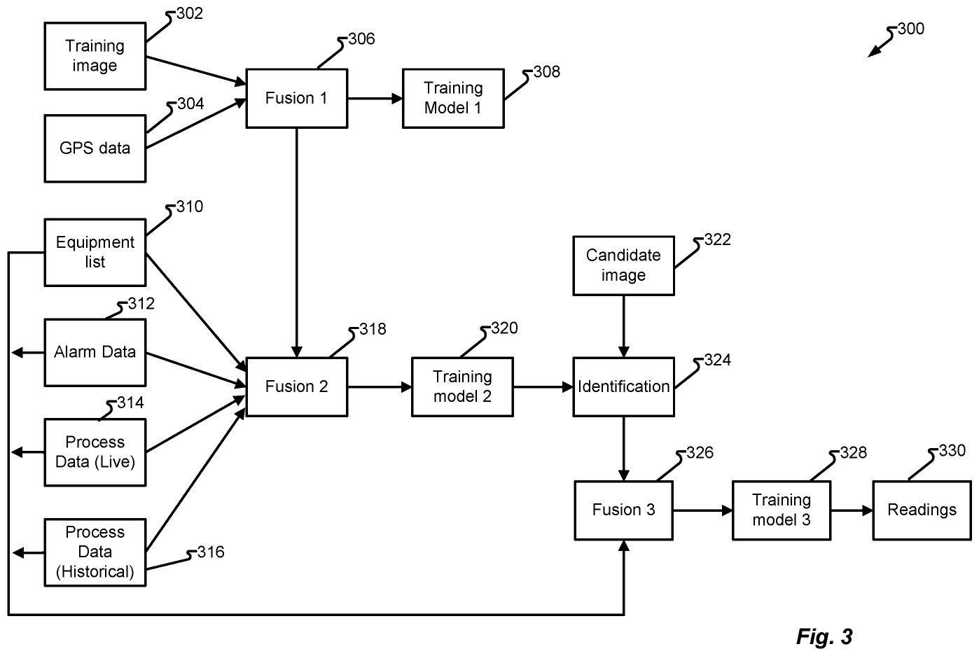

FIG. 3 depicts process flow 300 in accordance with embodiments of the present disclosure. In one embodiment, a training image is captured and made accessible in training image 302. Training images are provided to a neural network as a baseline for the visual appearance of industrial asset 106. Preferably training image 302 comprises a plurality of training images that differ (e.g., time of day/sun position, weather conditions, different operational stages, viewing angle, viewing distance, etc.). GPS data 304 (or other location information) is obtained in GPS data 304, such as the position from which each of the plurality of training images were captured. Training image 302 and GPS data 304 are provided to fusion 1 (306). Fusion 1 graphically combines GPS data 304 with training image 302, such as by converting GPS data 304 to image pixels and writing the pixels to training image 302. One output of fusion 1 (306) is training model 1 (308) comprising a training data set to train a neural network in the identification of industrial asset 106.

Fusion 2 (318) combines secondary information that may be used to identify a particular industrial asset 106, provide confirmation that a candidate image of an asset is industrial asset 106, or identify a candidate image of an asset is not industrial asset 106. Fusion 2 (318) may comprise one or more data elements including equipment list 310, alarm data 312, process data (live or real-time) 314, and process data (historical) 316. As an example, an image of a portion of an industrial site may comprise industrial asset 106 and any number of other features (e.g., walls, lights, other equipment, items stored nearby, etc.) However, if equipment list 310 identifies the type of equipment at the industrial site or at a particular portion thereof (e.g., GPS coordinates), such as a pump, then Fusion 2 (318) may exclude all elements not associated with pumps to identify industrial asset 106 therein. Similarly, alarm data 312 may indicate the type or degree of alarm. For example, industrial asset 106 may be a valve on a “hot” line (e.g., a fluid or gas at high temperature), an alarm may be triggered if the flow of high temperature materials goes outside a first range (e.g., a high temperature range) which may be distinguished from a different valve on a “cold” line (e.g., a fluid or gas at low temperature) and having alarms in a second range (a low temperature range). As a result, two valves may visually appear identical but be identified when one triggers a specific alarm, such as the “hot” line cooling to a certain temperature that would be considered normal (no alarm) for the “cold” line.

Fusion 2 (318) may similarly encode data in pixel form onto an image of industrial asset 106, or a previously modified image of industrial asset 106, such as the output of fusion 1 (306), and provide training model 2 (320) wherein a neural network identifies, confirms, or excludes the identity of a particular industrial asset 106 based on secondary data (i.e., data other than an image of the asset alone and the location of the asset).

Once the neural network is trained, candidate image 322 is provided to identification 324, wherein the neural network identifies the industrial asset or indicates identification of the industrial asset cannot be performed, such as due to a determination that there is no matching asset, poor image quality of the candidate image, etc.

In another embodiment fusion 3 (326) is provided with secondary data, such as equipment list 310, alarm data 312, process data (live) 314, process data (historical) 316, etc., which may further train the neural network in training model 3 (328). For example, training model 328 may consider a current visual state of industrial asset 106 as obtained from candidate image 322, which may be something highly dynamic (e.g., the level in a tank) or more static (e.g., a gradual increase in a rust spot, viewed at different times of the year/day due to the sun's position, etc.). Readings 330 may then trigger the recording, and any necessary responses (e.g. maintenance task), to a particular reading.

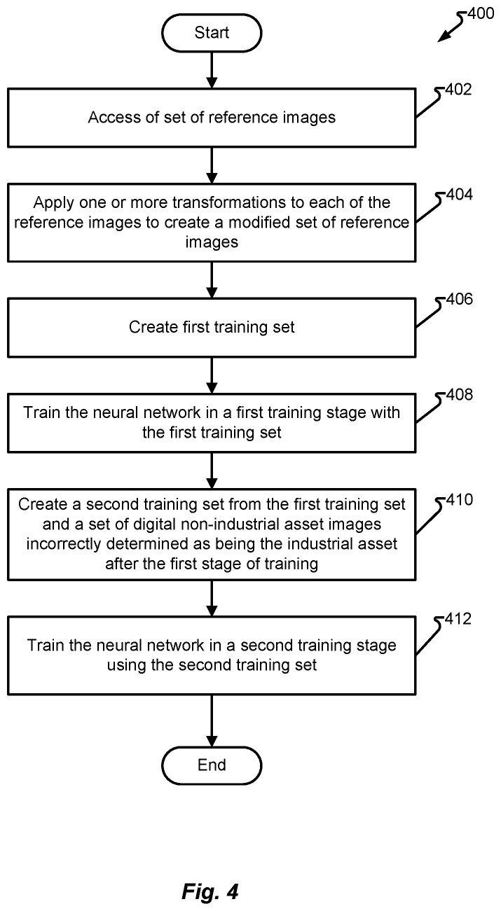

FIG. 4 depicts process 400 in accordance with embodiments of the present disclosure. In one embodiment, process 400 is embodied as machine-readable instructions maintained in a non-transitory memory that when read by a machine, such as processors of a server, cause the machine to execute the instructions and thereby execute process 400. The processor of the server may include, but is not limited to, at least one processor of server 114.

A neural network, as is known in the art and in one embodiment, self-configures layers of logical nodes having an input and an output. If an output is below a self-determined threshold level, the output is omitted (i.e., the inputs are within the inactive response portion of a scale and provide no output). If the self-determined threshold level is above the threshold, an output is provided (i.e., the inputs are within the active response portion of a scale and provide an output). The particular placement of the active and inactive delineation is provided as a training step or steps. Multiple inputs into a node produce a multi-dimensional plane (e.g., hyperplane) to delineate a combination of inputs that are active or inactive.

In one embodiment, a neural network is trained to identify a particular industrial asset from visual information (i.e., from digital image(s)), location information and, optionally, secondary information (e.g., sound, alarms, etc.). In step 402 a set of reference images of a particular industrial asset is accessed. Step 404 applies one or more transformations to each of the reference images to create a modified set of reference images. The transformations that create a modified set of reference images may include mirroring, rotating, cropping, magnifying, demagnifying, translating, smoothing, or contrast reduction, contrast increase, adding a superfluous visual element, and removing a superfluous visional element.

Step 406 then creates a first training set comprising the set of reference images, the modified set of reference images, and a set of digital non-industrial asset images. Step 408 then trains the neural network in a first training stage using the first training set.

Step 410 creates a second training set from the first training set and a set of digital non-industrial asset images that are incorrectly determined to be industrial asset images after the first stage of training. Step 412 trains the neural network in a second training stage using the second training set.

Similarly, the neural network may be trained to identify an industrial asset from secondary data alone or in combination with the image and location data. For example, step 402 accesses a set of reference images and secondary information for an industrial asset. Step 404 provides one or more transformations to create a modified set of reference images, location data, and secondary data. The transformations may include different values for an alarm, different location wherein a corresponding reference image was captured, or differing process data (live and historic), in addition to any transformation of the image (see above). A first training set is created in step 406 comprising the secondary data, the modified set of reference images, locations, and secondary data and a set of digital non-industrial asset images, location, and/or secondary data. Step 408 then trains the neural network in a first training stage with the first training set. Step 410 creates a second training set comprising the first training set and the set of digital non-industrial asset images, location, and/or secondary data and are incorrectly determined to be industrial asset images after the first training stage. Step 412 then trains the neural network in the second training stage using the second training set.

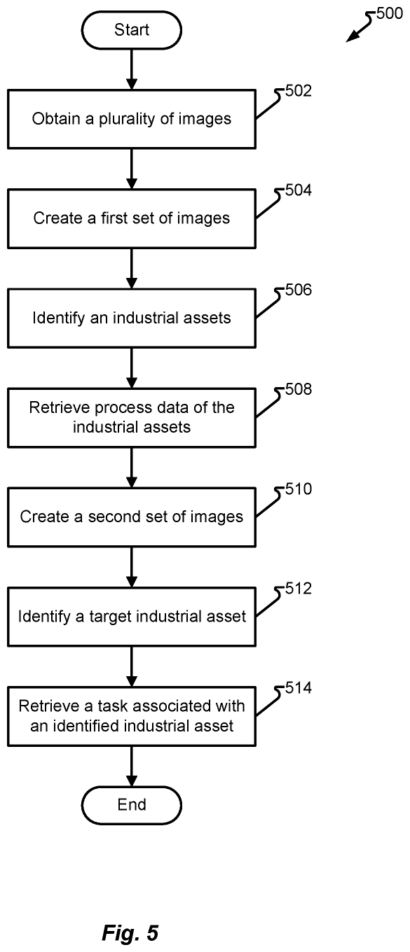

FIG. 5 depicts a process in accordance with embodiments of the present disclosure. In one embodiment, process 500 is embodied as machine-readable instructions maintained in a non-transitory memory that when read by a machine, such as processors of a server, cause the machine to execute the instructions and thereby execute process 500. The processor of the server may include, but is not limited to, at least one processor of server 114.

Process 500 begins and, in step 502, a plurality of images are obtained of an industrial asset. Step 504 creates a first set of images comprising the images of the industrial asset and location data (e.g., GPS coordinates, distance from an antenna, etc.). Step 506 identifies a plurality of target industrial assets based on the first set of images, which may further include providing the first set of images to a neural network trained to identify the industrial asset.

Step 508 retrieves process data associated with the plurality of target industrial assets (e.g., location, noise level, alarm condition, operational parameters, etc.). 510 creates a second set of images comprising the process data and the first set of images. Step 512 then identifies the target industrial asset among the plurality of target industrial assets, which may further comprise providing the second set of images to a neural network trained to identify the target industrial asset. Step 514 retrieves a task associated with the identified industrial asset.

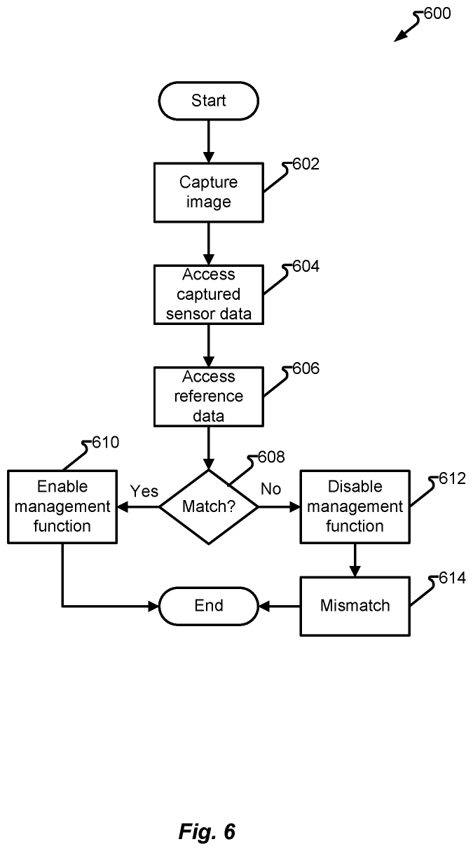

FIG. 6 depicts a process in accordance with embodiments of the present disclosure. In one embodiment, process 600 is embodied as machine-readable instructions maintained in a non-transitory memory that when read by a machine, such as processors of a server, cause the machine to execute the instructions and thereby execute process 600. The processor of the server may include, but is not limited to, at least one processor of server 114.

Process 600 begins and, in step 602, an image is captured of an industrial asset. Step 604 accesses captured sensor data, such as a captured environmental input. Sensor data may be one or more of location data or data from a secondary sensor (e.g., sound data, alarm data, process data, etc.). Step 606 accesses reference data associated with the industrial asset. Test 608 determines if there is a match between the reference data (e.g., a reference environmental input) and one or both of the captured image and the captured sensor data (e.g., a captured environmental input). Test 608 may be performed by a neural network trained to identify matches. Test 608 may determine a match on images alone, images with location information as compared to a reference image location, observed secondary sensor data (e.g., captured environmental input) as compared to a reference secondary sensor data (e.g., reference environmental input), or combinations thereof.

If test 608 is determined in the affirmative, step 610 enables a management function of the identified industrial asset. For example, step 610 may unlock or otherwise enable a previously locked operation, such as to accept a process control change, accept a software update, etc. Additionally or alternatively, step 610 may enable a management function on mobile device 104, such as to enable the entry of a value or change a state of industrial asset 106.

If test 608 is determined in the negative, step 612 disables a previously enabled management function and step 614 triggers a mismatch alert. Step 614 may indicate that equipment has been relocated but not properly documented or another discrepancy.

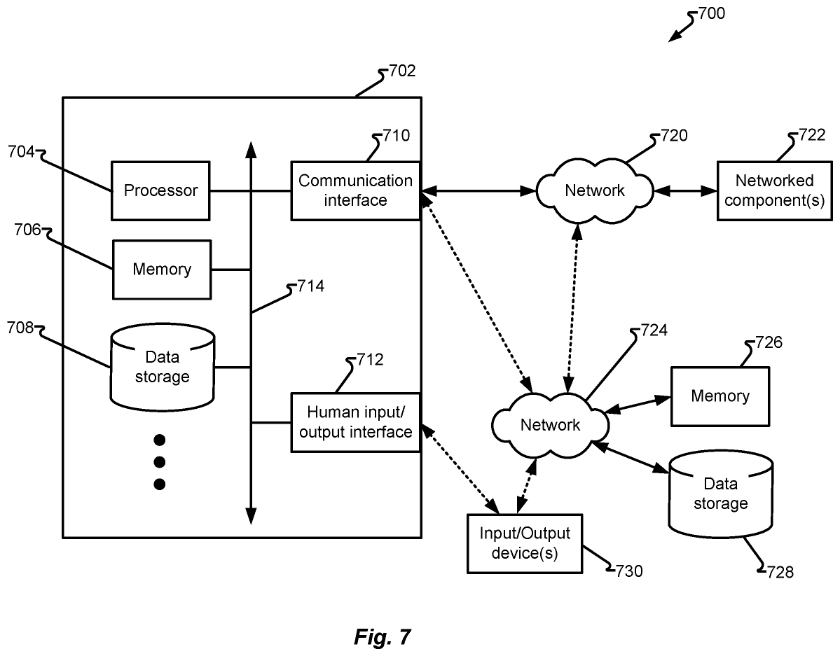

FIG. 7 depicts device 702 in system 700 in accordance with embodiments of the present disclosure. In one embodiment, mobile device 104 and server 114 may each be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may comprise programmable logic functionality, such as determined, at least in part, from accessing machine-readable instructions maintained in a non-transitory data storage, which may be embodied as circuitry, on-chip read-only memory, computer memory 706, data storage 708, etc., that cause the processor 704 to perform the steps of the instructions. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices). Processor 704 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize computer memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or configured to utilize one or more networks, such as network 720 and/or network 724.

Networking link 112 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.).

Additionally or alternatively, one or more other networks may be utilized. For example, network 724 may represent a second network, which may facilitate communication with components utilized by device 702. For example, network 724 may be an internal network to a business entity or other organization, whereby components are trusted (or at least more so) than networked components 722, which may be connected to network 720 comprising a public network (e.g., Internet) that may not be as trusted.

Components attached to network 724 may include computer memory 726, data storage 728, input/output device(s) 730, and/or other components that may be accessible to processor 704. For example, computer memory 726 and/or data storage 728 may supplement or supplant computer memory 706 and/or data storage 708 entirely or for a particular task or purpose. As another example, computer memory 726 and/or data storage 728 may be an external data repository (e.g., server farm, array, “cloud,” etc.) and enable device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of computer memory 706, data storage 708, computer memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, a switch, a port, or other communication component such that a particular output of processor 704 enables (or disables) input/output device 730, which may be associated with network 720 and/or network 724, to allow (or disallow) communications between two or more nodes on network 720 and/or network 724. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method of identifying tasks associated with an industrial asset, the method comprising:
obtaining a plurality of images associated with the industrial asset;
creating a first set of images, wherein the first set of images comprises location data associated with the plurality of images;
determining a plurality of target industrial assets based on the first set of images;
retrieving process data associated with the plurality of target industrial assets;
creating a second set of images, wherein the second set of images comprises the process data and the first set of images;
identifying a target industrial asset within the plurality of target industrial assets based on the second set of images, wherein the target industrial asset is identified by determining that a degree of match between an image of the target industrial asset and at least one image from the plurality of images satisfies a predetermined threshold; and
based on identifying the target industrial asset, automatically retrieving a task associated with the target industrial asset.

2. The method of claim 1, wherein creating the first set of images comprises: converting the location data to a first multi-dimensional dataset.

3. The method of claim 1, wherein creating the second set of images comprises: converting the process data to a second multi-dimensional dataset.

4. The method of claim 1, further comprising creating a third set of images, wherein the third set of images comprises the second set of images and the process data associated with the plurality of target industrial assets.

5. The method of claim 4, further comprising determining one or more measurement readings associated with the target industrial asset based on the third set of images.

6. A method, comprising:
capturing a captured image of a candidate industrial asset on a portable device;
in response to capturing the captured image, accessing a captured environmental input related to the candidate industrial asset;
accessing a data record comprising indicia of the candidate industrial asset and at least one reference image of the candidate industrial asset accompanied by a reference environmental input; and
determining that a degree of match between the captured image and the at least one reference image and between the captured environmental input and the reference environmental input is above a predetermined threshold; and
in response to determining that the degree of match is above the predetermined threshold, enabling at least one management feature of the candidate industrial asset.

7. The method of claim 6, further comprising:
determining that either the degree of match between the captured image and the reference image or the degree of match between the captured environmental input and the reference environmental input is not above the predetermined threshold, blocking an operation associated with the at least one management feature of the candidate industrial asset.

8. The method of claim 6, wherein the captured image comprises an artifact unique to a single industrial asset of all industrial assets at an industrial site.

9. The method of claim 6, wherein the captured environmental input comprises one or more acoustic values indicating at least one of volume, frequency, and variation in volume over a provided time unit, or variation in frequency over the provided time unit.

10. The method of claim 6, wherein of the captured environmental input comprises at least one of a global positioning system (GPS) coordinate, a sensor reading, alarm data, equipment master data, and process data.

11. The method of claim 10, further comprising:
retrieving, from a database, one or more historical environmental inputs associated with the candidate industrial asset;
validating that the candidate industrial asset corresponds to a targeted industrial asset;
in response to validating that the candidate industrial asset corresponds to the targeted industrial asset, retrieving a task associated with the targeted industrial asset; and
automatically filling in at least one measurement reading for the task associated with the targeted industrial asset.

12. The method of claim 6, further comprising:
retrieving historian data comprising historical readings associated with the candidate industrial asset; and
merging the historian data with the captured image.

13. The method of claim 12, further comprising:
predicting a reading for the candidate industrial asset based on the historian data; and
verifying the predicted reading for the candidate industrial asset matches an actual reading for the candidate industrial asset.

14. The method of claim 6, wherein determining the degree of match between the captured image and the reference image comprises providing the captured image to a neural network trained to identify industrial assets from images and providing indica of the match therefrom.

15. The method of claim 14, further comprising:
collecting a set of industrial asset images from a database;
applying one or more transformations to each industrial asset image including mirroring, rotating, cropping, magnifying, demagnifying, translating, smoothing, or contrast reduction to create a modified set of digital industrial asset images;
creating a first training set comprising the collected set of digital industrial asset images, the modified set of digital industrial asset images, and a set of digital non-industrial asset images;
training the neural network in a first stage using the first training set;
creating a second training set for a second stage of training comprising the first training set and digital non-industrial asset images that are incorrectly detected as industrial asset images after the first stage of training; and
training the neural network in the second stage using the second training set.

16. The method of claim 6, further comprising:
collecting at least one of process data and alarm data associated with an industrial site;
creating a training set based on the collected at least one of process data and alarm data associated with the industrial site;
training a neural network using the training set;
confirming that the neural network has been sufficiently trained using the training set; and
providing the neural network, once sufficiently trained, with the captured environmental input for purposes of identifying the candidate industrial asset.

17. The method of claim 6, further comprising:
collecting a set of industrial asset sensor values from a database;
applying one or more transformations to each industrial asset sensor value in the set of industrial asset sensor values;
fusing the captured image with the one or more transformations to each industrial asset sensor value by changing pixel data in the captured image.

18. A portable device for managing an industrial asset, comprising:
a processor coupled to computer memory comprising computer-executable instructions;
a data storage;
a camera operable to capture an image of an already-captured image and provide the image of the already-captured image to the processor thereby enabling the processor to;
determines a captured environmental input related to an industrial asset in the image of the already-captured image;
obtain a reference image of the industrial asset;
obtain a reference environmental input of the industrial asset;
determine that a degree of match between the image of the already-captured image and the reference image and/or between the captured environmental input and the reference environmental input is above a predetermined threshold; and
in response to determining that the degree of match is above the predetermined threshold, enable at least one management feature of the industrial asset.

19. The portable device of claim 18, further comprising a display device, wherein the processor is further enabled to:
display information describing a task associated with the at least one management feature of the industrial asset.

20. The portable device of claim 18, wherein the captured environmental input comprises at least one of a global positioning system (GPS) coordinate, a sensor reading, alarm data, equipment master data, and process data.
